(19) United States
(12) Patent Application Publication
(10) Pub. No.: US 2026/0264096 A1
(43) Pub. Date: Sep. 10, 2026

(54) SPRAY HEAD

(71) Applicant: Kohler Mira Limited, Cheltenham (GB)

(72) Inventors: Simon Westgate, Cheltenham (GB); Oliver Jones, Gloucester (GB)

(21) Appl. No.: 19/535,665

(22) Filed: Feb. 10, 2026

(30) Foreign Application Priority Data
Mar. 5, 2025 (GB) 2503159.2

(51) Int. Cl. B05B 1/18; B05B 1/30

(52) U.S. Cl. CPC B05B 1/1823; B05B 1/3006

(57) ABSTRACT

A spray head is provided with a fluid inlet and a spray plate. The spray plate includes a plurality of spray plate outlet apertures. A flow splitter is located between the fluid inlet and the spray plate. The flow splitter includes a plurality of exit apertures through the flow splitter. The perimeter of each exit aperture is arranged to form a valve seat. A plurality of elastomeric projections are located between the flow splitter and the spray plate. Each elastomeric projection is arranged to contact a respective valve seat when relaxed so as to block fluid flow, and to deform away from the respective valve seat when fluid pressure from the inlet exceeds a threshold. A ratio of the number of spray plate outlet apertures to the number of elastomeric projections is at least 4:1.

### CROSS REFERENCE

This application claims priority to UK Application No. 2503159.2, filed Mar. 5, 2025, the entirety of which is hereby incorporated by reference.

### FIELD OF THE INVENTION

The present invention relates to a spray head, arranged to prevent dripping when the spray head is not in use.

### BACKGROUND OF THE INVENTION

Spay heads with drip-reducing mechanisms are known. Reducing dripping when the spray head is not in use provides environmental benefits by reducing the production of wastewater, and accordingly reduces water bills for the user. Reducing dripping from a spray head when not in use also provides a better user experience by eliminating the unwanted dripping noise and damp that comes with a dripping spray head.

### BRIEF DESCRIPTION OF THE DRAWINGS

Example implementations of the invention will now be described in relation to the accompanying drawings, in which:

FIG. 1 is an exploded view of an example embodiment of a spray head.

FIG. 2 is a perspective view of an upper side of an example embodiment of a flow splitter.

FIG. 3 is a top view of an upper side of an example embodiment of a flow splitter.

FIG. 4 is a bottom view of a lower side of an example embodiment of a flow splitter.

FIG. 5 is a perspective view of an upper side of an example embodiment of a separator.

FIG. 6 is a top view of an upper side of an example embodiment of a separator.

FIG. 7 is a sectional view of an example embodiment of a spray head when the fluid flow through the spray head is turned off.

FIG. 8 is a top perspective view of an upper side of an example embodiment of a spray plate.

FIG. 9 is a close-up of a portion of the sectional view of FIG. 7, showing an elastomeric projection.

FIG. 10 is a sectional view of an example embodiment of a spray head when the fluid flow through the spray head is turned on.

FIG. 11 is a close-up of a portion of the sectional view of FIG. 10, showing an elastomeric projection.

### DETAILED DESCRIPTION OF THE DRAWINGS

It is an object of the invention to provide a spray head with an improved drip-reducing mechanism. The present disclosure is disclosed in the context of shower systems but is not limited to shower systems. Aspects of the present disclosure that are depicted in the illustrated embodiments or otherwise described herein may be used in conjunction with other ablutionary fittings or water distribution systems. Water distribution systems encompassed by the present disclosure include, without limitation, water distribution systems that dispense water for consumption and/or washing and water distribution systems used for private, public, domestic, residential, commercial, and/or industrial use. Water distribution systems such as, for example and without limitation, showers, baths, washtubs, hot tubs, sinks, fountains, water dispensers, and the like may incorporate aspects of the present disclosure and are encompassed herein. Example water distribution systems may include an outlet dispensing water or other fluid. The outlet may include any suitable device that is configured to dispense liquid or water. The outlet may include an ablutionary fitting, such as, for example and without limitation, a showerhead, shower spray, wand hand shower, faucet, wand, spigot, tap, spout, or the like. The outlet can include a single outlet or more than one outlet. Where the outlet includes multiple, e.g., two or more outlets, the outlets can be similar types of outlets or dissimilar types of outlets. Elements and features described with reference to one illustrated embodiment are not limited to that embodiment only; the features and elements of any one or more of the illustrated embodiments can be utilized in any other embodiment in any combination.

According to a first aspect of the invention, there is provided a spray head, the spray head comprising: a fluid inlet; a spray plate comprising a plurality of spray plate outlet apertures; a flow splitter located between the fluid inlet and the spray plate, the flow splitter comprising a plurality of exit apertures through the flow splitter, and wherein the perimeter of each exit aperture is arranged to form a valve seat; and a plurality of elastomeric projections located between the flow splitter and the spray plate, each elastomeric projection being arranged to contact a respective valve seat when relaxed so as to block fluid flow, and to deform away from the respective valve seat when fluid pressure from the inlet exceeds a threshold. A ratio of the number of spray plate outlet apertures to the number of elastomeric projections is at least 4:1 (i.e. there is a minimum of four spray plate outlet apertures for each elastomeric projection, on average).

In various implementations the ratio may be in the range from 4:1 to 20:1, or from 8:1 to 20:1, and/or optionally may be at least 8:1 or at least 10:1.

The fluid inlet allows the spray head to be connected to any suitable fluid source (typically a water source), typically one or more water pipes or a shower hose. This connection may be made by screwing, welding, gluing, or clipping (or by using any other suitable means of connection) the spray head to a fluid supply pipe or other fluid outlet provided in a desired area.

The connection of the spray head to the fluid source may allow for a wall-mounted spray head, a ceiling-mounted spray head, or a hand-held spray head. A person skilled in the art would appreciate that the installation process may vary depending on spray head type, and the user's desired orientation of the spray head.

Each spray plate outlet aperture may be associated with a conical extension protruding around the perimeter of the aperture, and may therefore be referred to as a nozzle. The conical extension may be provided to funnel the fluid from the internal housing of the spray head through the respective spray plate outlet aperture. The conical extensions may provide the desired direction, flow rate, shape and/or pressure of the fluid stream emerging from the spray head.

Alternatively, each spray plate outlet aperture may be a substantially flat hole. In such implementations, describing the outlet apertures as “nozzles” may not be appropriate.

Each elastomeric projection may impermeable, such that fluid can only pass through the flow splitter when the elastomeric projection is deformed away from its respective valve seat. Each elastomeric projection may be dome-shaped.

Spray heads comprising elastomeric members to reduce unwanted dripping are known. For example, prior art spray heads may include a single, large elastomeric member arranged to block the fluid inlet into the spray head body as a whole when not in use. However, the inventors appreciated that it can be difficult to ensure that a single elastomeric member remains robust enough to completely seal the fluid inlet after repeated use. In this event, the desired drip-stopping effect may not be achieved. Additionally, using only a single elastomeric member reduces the spray head to a single point of failure, destroying the drip-reducing mechanism entirely should the elastomeric member fail.

Other prior art spray heads are designed with an elastomeric member at the base of each nozzle. In this case, each elastomeric member is small and arranged to block its respective individual nozzle (e.g. by sitting inside the nozzle, or by creating a seal over it) when the spray head is not in use. However, the inventors appreciated that the size of elastomeric members in such spray heads may make manufacturing difficult or more expensive. Spray heads of this type may also be susceptible to fault, for example by elastomeric members wrongly deforming and/or clogging nozzles. Cleaning such a spray head may also be challenging.

The inventors appreciated that providing a spray head comprising a plurality of apertures in a flow splitter, the perimeters of which form valve seats, and a plurality of elastomeric projections located between a spray plate and the flow splitter arranged to contact a respective valve seat when relaxed so as to block fluid flow, and deform away from the respective valve seat when fluid pressure exceeds a threshold, increases the drip-reducing ability of the mechanism and reduces the chances of fault.

By completely sealing the respective exit aperture through flow splitter when the spray head is not in use, each elastomeric projection prevents part of the flow of fluid from the fluid source onto the spray plate, therefore significantly reducing the likelihood of unwanted dripping out of the spray head.

The flow splitter may be or comprise a plate arranged to block and split flow, which may be referred to as a blocking plate. The flow splitter may comprise a plurality of holes through the blocking plate, through which fluid can flow-each of these holes provides an exit aperture of the plurality of exit apertures of the flow splitter.

The flow splitter may be arranged to provide a plurality of separate fluid channels joined only at the fluid inlet, each fluid channel providing one exit aperture of the plurality of exit apertures through the flow splitter. An outlet of each fluid channel may therefore provide an exit aperture of the plurality of exit apertures of the flow splitter. In such implementations, if one elastomeric projection were to fail only its respective portion of the overall flow would be able to reach the spray plate, as the other elastomeric projections may still hold back their portions.

Optionally, the number of elastomeric projections is equal to the number of exit apertures of the flow splitter.

The number of elastomeric projections may not exceed one per 4 cm² of the area of the spray plate, and optionally may not exceed one per 6 cm² or 10 cm² of the area of the spray plate. In some implementations, particularly for larger spray heads, there may be no more than one elastomeric projection per 20 cm² of spray plate area (e.g. providing a 5 cm diameter area around each dome).

Having no more than one elastomeric projection per 4 cm² of the area of the spray plate provides an advantageous balance between the difficulty in manufacturing a spray head with many elastomeric members, and the risk of failure posed by having only a single elastomeric member, and hence a single point of failure.

Depending on the size of the spray head and/or expected flow rates, and accordingly the volume of fluid flow through the spray head, the number of elastomeric projections used and the design of the flow splitter may be adjusted to distribute the pressure exerted by the fluid on each elastomeric projection appropriately. It is advantageous if the fluid pressure is exerted approximately evenly between the elastomeric projections, so as not to overly strain an individual elastomeric projection. Overly straining a single elastomeric projection may lead to reduced elasticity and permanent deformation of said projection, weakening the drip-reducing abilities of the spray head.

Optionally, each spray plate outlet aperture has a raised rim around a perimeter of the spray plate outlet aperture and extending towards the flow splitter. Advantageously, the maximum height of each elastomeric projection is greater than the upwards extension of each raised rim of the spray plate outlet apertures. This allows the region in which the spray plate outlet apertures are located to be sealed when the elastomeric projection is relaxed, such that no fluid from the fluid source can flow through the spray plate outlet apertures and out of the spray head. Additionally, the raised rim of each spray plate outlet aperture assists in retaining any residual fluid left in the cavity of the spray head when the spray head is turned off, provided that the level is below that of the rim, reducing unwanted dripping.

According to a second aspect of the invention, there is provided a spray head, the spray head comprising: a fluid inlet; a spray plate; a flow splitter located between the fluid inlet and the spray plate, the flow splitter providing a plurality of separate fluid channels joined only at the fluid inlet, each fluid channel having a single exit aperture through the flow splitter, and wherein the perimeter of the aperture is arranged to form a valve seat; and a plurality of elastomeric projections located between the flow splitter and the spray plate, each elastomeric projection being arranged to contact a respective valve seat when relaxed so as to block fluid flow, and to deform away from the respective valve seat when fluid pressure from the fluid inlet exceeds a threshold. The number of elastomeric projections is equal to the number of exit apertures of the flow splitter.

Given the separation of the fluid channels of the flow splitter, if one elastomeric projection were to fail only its respective portion of the overall flow would be able to reach the spray plate, as the other elastomeric projections can still hold back their portions of the liquid within the flow splitter.

The spray plate comprises a plurality of spray plate outlet apertures, which may be provided by nozzles. The number of exit apertures of the flow splitter, and therefore the number of elastomeric projections is typically much lower than the number of spray plate outlet apertures, typically by a factor of at least three.

The number of elastomeric projections may not exceed one per 4 cm² of the area of the spray plate, and optionally may not exceed one per 10 cm² of the area of the spray plate.

Any feature described with respect to the first aspect may be used in conjunction with this second aspect.

According to a third aspect of the invention, there is provided a spray head, the spray head comprising: a fluid inlet; a spray plate; a flow splitter located between the inlet and the spray plate, the flow splitter comprising a plurality of exit apertures through the flow splitter, wherein the perimeter of each exit aperture is arranged to form a valve seat; and a plurality of elastomeric projections located between the flow splitter and the spray plate, each elastomeric projection being arranged to contact a respective valve seat when relaxed so as to block fluid flow, and to deform away from the respective valve seat when fluid pressure from the inlet exceeds a threshold. The total number of elastomeric projections does not exceed one per 4 cm² of the area of the spray plate.

Optionally, the number of elastomeric projections may not exceed one per 6 cm² or 10 cm², of the area of the spray plate.

Optionally, the number of elastomeric projections is equal to the number of exit apertures of the flow splitter. This may be advantageous in ensuring that each exit aperture of the flow splitter can be appropriately sealed by a respective elastomeric projection when the spray head is in use.

The spray plate comprises a plurality of spray plate outlet apertures. Optionally, each spray plate outlet aperture has a raised rim around a perimeter of the spray plate outlet aperture and extending towards the flow splitter, wherein the maximum height of each elastomeric projection is greater than the upwards extension of each raised rim of the spray plate outlet apertures.

Any feature described with respect to the first or second aspect may be used in conjunction with this third aspect.

In any preceding aspect, one or more of the following features may be provided: the largest width of each exit aperture of the plurality of exit apertures of the flow splitter is at least one twentieth, and optionally at least one tenth of the largest width of the spray plate; the largest width of each exit aperture is at least 2.5 times greater than the largest width of each spray plate outlet aperture; the number of elastomeric projections does not exceed twenty, and optionally may not exceed fifteen; each elastomeric projection is dome shaped; each elastomeric projection is impermeable, such that fluid can only pass through the flow splitter when the elastomeric projection is deformed away from its respective valve seat; the spay plate may divided into a plurality of spray plate regions such that fluid cannot flow between the spray plate regions; and/or in implementations with separated spray plate regions, each spray plate region may comprise a single elastomeric projection.

Here, the “largest width” refers to a longest dimension of the aperture area—i.e. the diameter for a circular aperture, or the diagonal between opposite corners for a square or rectangular aperture.

Optionally, the largest width of each exit aperture is at least 0.2 cm, 0.3 cm or 0.4 cm, and optionally at least 0.5 cm. Optionally, the largest width of each exit aperture in the range from 0.2 cm to 3 cm, or from 0.5 cm to 3 cm, or from 1 cm to 3 cm.

According to a fourth aspect of the invention, there is provided a spray head comprising: a fluid inlet; a spray plate comprising a plurality of spray plate outlet apertures; a flow splitter arranged to split fluid flow from the inlet into a plurality of portions and to direct each portion to a different region of the spray plate; and a separator arranged to define borders of the spray plate regions, so defining a plurality of spray plate regions each comprising at least one of the spray plate outlet apertures, and to prevent fluid flow between the spray plate regions. The separator defines at least eight spray plate regions, each spray plate region comprising a single inlet from the flow splitter.

Spray heads comprising fluid diverters are known. Such fluid diverters prevent fluid from flowing across the whole area of the spray plate for the purpose of mode-changing spray heads (i.e. different spray patterns or types depending on the user's preference), and can be adjusted to divert some or all of the fluid flow to different regions of the spray plate so as to produce different spray patterns. The inventors appreciated that providing a spray head comprising a flow splitter and a plurality of spray plate regions could also be beneficial in other scenarios, even when changing of spray pattern is not contemplated, in particular to divide the internal volume of a spray head such that only a fraction of the water is able to leave through a particular spray plate outlet aperture. In particular, designs in which the fluid cannot flow between regions may be beneficial in reducing unwanted dripping from the spray head when it is not in use. A particular benefit may be seen in implementations in which at least one of the following applies: none of the spray plate regions extends fully around the central point of the spray head; none of the spray plate regions extends the full length or width of the spray head; and/or each spray plate region has an area significantly lower than the spray plate area.

Designs in which the fluid cannot flow between regions on the spray plate may be particularly advantageous in large spray heads that tend to store increased volumes of fluid internally when not in use. If no spray plate regions extend fully around the central point of the spray head, nor extend the full length or width of the spray head, pooling of large volumes of fluid at one side of the spray plate may be reduced.

In instances where a large volume of fluid may be pooled within one region of a spray head (for example, if the spray head has been tipped or is positioned at an angle rather than horizontally), the fluid may have a depth or pressure great enough to mount the raised rim (where present) of a spray plate outlet aperture and begin to drip out of the spray head. This generates unwanted wastewater and a potentially irritating dripping sound. Including a flow splitter that prevents fluid from flowing between distinct regions on the spray plate may prevent the fluid from gathering in one region, therefore reducing unwanted dripping of the nature described.

The separator may provide one or more barriers which, optionally together with edges of the spray plate, are arranged to define the perimeter, or border, of each spray plate region. The barriers prevent the fluid from flowing between the spray plate regions.

The single inlet to each spray plate region may be sealable, so as to prevent water flow into the region when the inlet is sealed. For example, it may be sealed by an elastomeric projection as described above, or any other valve design.

Each spray plate region may have an extent parallel to a width of the spray plate of less than a third of the total spray plate width, and an extent parallel to a perimeter of the spray plate of less than a third of the total spray plate perimeter.

Optionally, the separator comprises a plurality of walls extended behind the spray plate, the walls arranged to prevent fluid flow between the spray plate regions. The walls are an example of a barrier.

The plurality of walls may comprise: a plurality of first walls radiating from a central point on the spray plate so as to divide the spray plate into a plurality of segments; and at least one second wall extending between adjacent pairs of first walls, the second wall arranged to sub-divide the segments, so forming the plurality of spray plate regions.

According to a fifth aspect of the invention, there is provided a spray head, the spray head comprising: a fluid inlet; a spray plate comprising a plurality of spray plate outlet apertures; a flow splitter arranged to split fluid flow from the inlet into a plurality of portions and to direct each portion to a different region of the spray plate; and a separator arranged to define borders of the spray plate regions, so defining a plurality of spray plate regions each comprising at least one of the spray plate outlet apertures, and to prevent fluid flow between the spray plate regions. Each spray plate region has an extent parallel to a width of the spray plate of less than a third of the total spray plate width, and an extent parallel to a perimeter of the spray plate of less than a third of the total spray plate perimeter.

Optionally, the separator comprises a plurality of walls as described for the fourth aspect. There may be a single inlet to each spray plate region.

According to a sixth aspect of the invention, there is provided a spray head, the spray head comprising: a fluid inlet; a spray plate comprising a plurality of spray plate outlet apertures; a flow splitter arranged to split fluid flow from the inlet into a plurality of portions and to direct each portion to a different region of the spray plate; and a separator arranged to define borders of the spray plate regions, so defining a plurality of spray plate regions each comprising at least one of the spray plate outlet apertures, and to prevent fluid flow between the spray plate regions, wherein the separator comprises a plurality of walls extended behind the spray plate, the walls arranged to prevent fluid flow between the spray plate regions, wherein the plurality of walls comprises: a plurality of first walls radiating from a central point on the spray plate so as to divide the spray plate into a plurality of segments; and at least one second wall extending between adjacent pairs of first walls, the second wall arranged to sub-divide the segments, so forming the plurality of spray plate regions.

Each spray plate region may have an extent parallel to a width of the spray plate of less than a third of the total spray plate width, and an extent parallel to a perimeter of the spray plate of less than a third of the total spray plate perimeter. There may be a single inlet to each spray plate region.

In any of the fourth, fifth, or sixth aspects, or in implementations of any of the preceding aspects in which a separator as described for these aspects is provided, one or more of the following features may also be provided: the plurality of walls may comprise n first walls radiating from a central point on the spray plate so as to divide the spray plate into n spray plate regions wherein n≥2, and optionally n≥3 or n≥4; at least one wall in the plurality of walls may extend along the length of the maximum width of the spray plate; each first wall of the plurality of walls may extend from the central point on the spray plate (or a region thereof) to the edge of the spray plate; each spray plate outlet aperture may be located within a spray plate region of the plurality of spray plate regions; the separator may be provided by the spray plate; the flow splitter may be fixed such that the proportion of fluid flow from the fluid inlet that is directed to each spray plate region does not change; the separator and the flow splitter may each have a constant set position and shape; at least one of the following may apply: (a) each spray plate region has a substantially equal area; and (b) the number of spray plate outlet apertures in each spray plate region is substantially equal; all of the spray plate regions may extend only partially around the central point of the spray head (e.g. by no more than 180°, and optionally by no more than 90° or 100°), i.e. none of the spray plate regions extend fully around the central point of the spray head; each spray plate outlet may have a raised rim around a perimeter of the spray plate outlet aperture and extending towards the flow splitter; and/or each spray plate region may comprise at least ten spray plate outlet apertures.

As described above, designs in which the fluid cannot flow between regions may be beneficial in reducing unwanted dripping from the spray head when it is not in use. This may be particularly advantageous in large spray heads that store large volumes of fluid internally when not in use. If no spray plate regions extend fully around the central point of the spray head, nor extend the full length or width of the spray head, pooling of large volumes of fluid at one side of the spray plate may be reduced.

Additionally, having a flow splitter fixed such that the proportion of fluid flow that is directed to each spray plate region is unchanging may be beneficial in ensuring that there is an even distribution of fluid entering each distinct spray plate region. Accordingly, the distribution of fluid exiting from the spray plate may be regular and even across the area of the spray plate, enhancing user experience.

Providing a spray head wherein each spray plate region has a substantially equal area and/or the number of spray plate outlet apertures in each spray plate region is substantially equal may provide a similarly advantageous effect.

It will be appreciated that the elastomeric projections and separated spray plate regions of any combination of the preceding aspects may be used together to further improve drip prevention, offering a synergy when used in combination.

According to a seventh aspect of the invention there is therefore provided, by way of example, a spray head comprising: a fluid inlet; a spray plate comprising a plurality of spray plate outlet apertures; a flow splitter located between the fluid inlet and the spray plate, the flow splitter comprising a plurality of exit apertures through the flow splitter, and wherein the perimeter of each exit aperture is arranged to form a valve seat; a plurality of elastomeric projections located between the flow splitter and the spray plate, each elastomeric projection being arranged to contact a respective valve seat when relaxed so as to block fluid flow, and to deform away from the respective valve seat when fluid pressure from the inlet exceeds a threshold; and a separator arranged to define borders of spray plate regions, so defining a plurality of spray plate regions each comprising at least one of the spray plate outlet apertures, and to prevent fluid flow between the spray plate regions.

Although a plurality of elastomeric projections arranged to block fluid flow (as in the first, second, and third aspects) and a separator arranged to prevent fluid flow between spray plate regions (as in the fourth, fifth, and sixth aspects) both work well individually to reduce unwanted dripping from a spray head, the two approaches may also be combined in a single spray head to provide a further improved drip-reducing mechanism. A single spray head incorporating both approaches may simultaneously benefit from the aperture-sealing effect provided by the elastomeric projections and the tip-proof and distribution effects provided by the separator. The combination of these effects may work together to significantly reduced the unwanted drip from a spray head when not in use, therefore enhancing user experience. The flow splitter outlet apertures may be located in suitable positions for the defined spray plate regions accordingly, and may be provided in equal numbers to the number of spray plate regions.

In any preceding aspect, the spray plate may have a total area greater than 200 cm², and optionally greater than 500 cm², 700 cm², 800 cm², or 1000 cm². Typically, the volume of water retained within a spray head increases with size of the spray head, and the inventors appreciated that dripping is a particular issue for larger spray heads (e.g. with areas of around 2000 cm²), so increasing a need for anti-drip technology for larger spray heads.

Features described with respect to any aspect may be provided in conjunction with any other aspect, mutatis mutandis.

In the following description, like reference numerals are used for like components.

For ease of description, the orientation of components as described below is in keeping with the orientation of components presented in the figures. A person skilled in the art will appreciate that the orientation of parts may vary, and so position-descriptive terms (e.g. top, bottom, upper, lower) are provided for ease of description only and not to be taken as limiting.

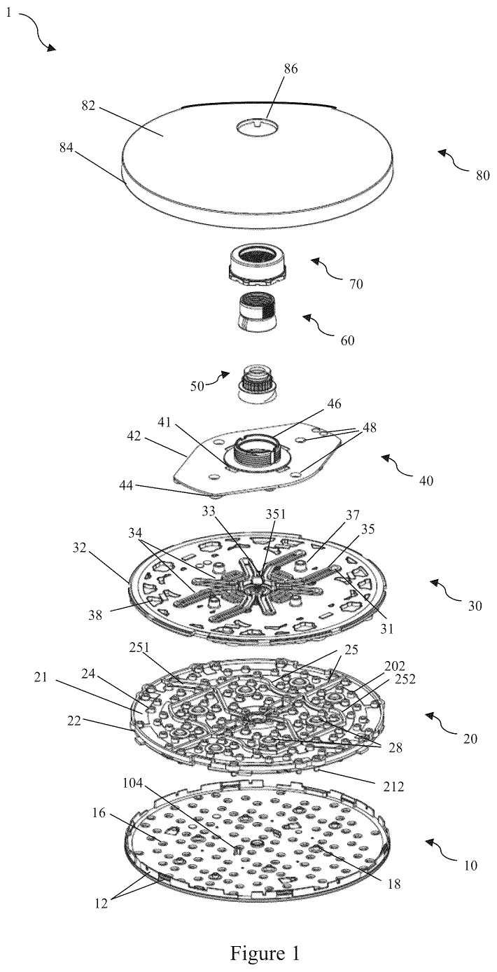

FIG. 1 shows an exploded view of an example implementation of the drip-reducing spray head 1, which in this case is a shower head 1 intended for an overhead shower. A cover 80 is located at the top of the spray head 1 and orientated furthest away from the user when the spray head 1 is in use. The cover 80 is visible in use.

The cover 80 is substantially disc-shaped in the implementation shown, but may be differently shaped—e.g. substantially square or rectangular, or having a handle extending from one side for a shower hand-set, in other implementations. The cover 80 is fixedly connected to the spray plate 10 in the implementation being described. In other implementations, for example in some implementations allowing for changes in spray pattern in use, the cover 80 may be movably connected to the spray plate 10 (e.g. rotatably connected).

The spray plate 10 is located nearest to the user when the spray head 1 is in use. The cover 80 and the spray plate 10 together form a spray head housing, the spray head housing defining a cavity 900 within which all remaining components are disposed.

The spray plate 10 has a plurality of spray plate outlet apertures 16 therethrough, as described in more detail below. The spray plate outlet apertures 16 are arranged to provide a spray pattern for the user in use. The spray plate outlet apertures 16 are typically round, with a diameter in the range from 0.2 mm to 5 mm, and optionally of around 0.7 mm.

In the example implementation shown in FIG. 1, the cover 80 has a main body 82 and an extended rim 84. The main body 82 has the shape of a shallow cone 82, extending between a central inlet aperture 86 and a larger circular perimeter. The rim 84 along the perimeter of the cover's main body 82 extends downwards, towards the spray plate 10. The rim 84 has fixings used to connect the cover 80 to the spray plate 10, and/or to any other component disposed within the spray head housing 80, 10. These fixings may be provided on the internal walls of the rim 84, so as not to affect the aesthetic appearance of the spray head 1. In some examples, the rim 84 may be integral with cover's main body 82; in other examples the rim 84 may be provided as an individual component and connected to the cover's main body 82 during installation.

The rim 84 of various implementations may have a minimum depth of at least one centimetre, or optionally at least three centimetres, and in the example shown has a depth of around 2 cm.

Alternatively, the cover 80 may be substantially dome-shaped, or the main body 82 may be substantially flat so providing a disc-shaped housing 80, 10 with a flat top. A dome-shaped cover may have a rim along the perimeter of the circular base, the rim used to connect the cover to the other spray head components. In other examples, a dome-shaped cover may not require an extended rim, and the internal walls of the dome may provide suitable fixtures for connecting the cover to the spray plate or other spray head components.

In yet other examples, the cover 80 may be square, rectangular, triangular or any other suitable shape. The cover may be an irregular shape, for example designed to match the outline of a user's profile from above (e.g. including extending the full width of a user's shoulders). A rim extending along the perimeter of the cover therefore provides an outline of an equivalent shape, within which the remainder of the spray head components may be disposed.

The cover 80 is typically made from a rigid, hard material, for example a polymeric material, metal or any other suitable material, and is made from a rigid plastic in the implementation pictured. Providing a rigid cover 80 for the spray head 1 reduces the likelihood of damage during the transportation and/or installation process. A rigid cover 80 also provides suitable protection to the internal components of the spray head 1 in normal use.

As shown in FIG. 1, the cover 80 has an aperture 86 located approximately central to the cover 80. The aperture 86 provides a fluid inlet and allows the spray head 1 to be connected to any suitable fluid source, typically one or more water pipes or a shower hose. This connection may be made by screwing, welding, gluing, or clipping (or by using any other suitable means of connection) the spray head to a fluid supply pipe or other fluid outlet provided in a desired area.

The particular fixing of the spray head 1 to the fluid source may allow for a wall-mounted spray head, a ceiling-mounted spray head, or a hand-held spray head. A person skilled in the art would appreciate that the installation process may vary depending on the user's desired orientation of the spray head.

In other examples, the cover 80 may have more than one aperture 86, each providing a fluid source into the spray head. A plurality of apertures through the cover may be advantageous, for example, if the hot water and cold water supplies are provided separately and are intended to mix within the spray head. Alternatively, a plurality of apertures may be beneficial for particularly large showerheads where multiple fluid sources may be required to maintain a desirable fluid pressure through the spray head.

In the implementation pictured, three connectors 50, 60, 70 are provided to facilitate connection of the spray head 1 to the fluid inlet. These connectors 50, 60, 70, which may have one or more sealing gaskets, are arranged to provide a watertight connection to a fluid inlet pipe whilst optionally also allowing for some rotation and/or tilting of the spray head 1 with respect to the fluid inlet pipe. In other examples, any number of screws and/or other connectors may be provided to perform a similar function. Additionally or alternatively, the fixture may be provided by one or a combination of screwing, welding, gluing, clipping, or any other suitable means. In the implementation pictured, the connector 70 screws onto a plate 40 described in more detail below. The internal components of the spray head 1 are then secured to this plate 40, as described below. It will be appreciated that, in other implementations, any suitable connection and securing approach known in the art may be used instead of, or as well as, the plate and connectors 40, 50, 60, 70 shown for this implementation.

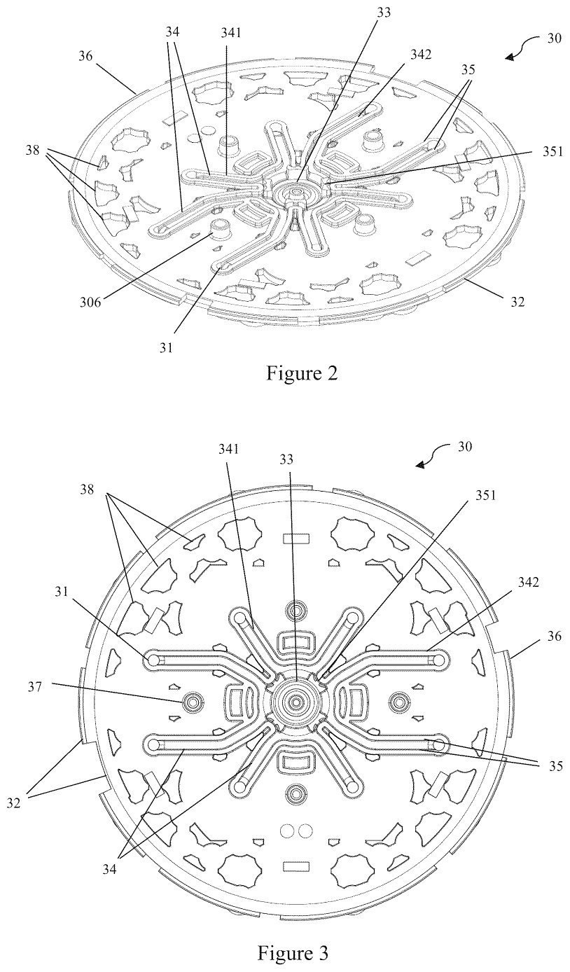

FIG. 2 shows a perspective view of the upper side of the flow splitter 30 of the spray head 1 of FIG. 1. The flow splitter 30 is arranged to receive fluid from the fluid inlet, and to split the fluid into a plurality of individual streams. Each stream passes through the flow splitter 30 via a different aperture 31. Splitting the fluid input into a plurality of distinct streams may provide benefits for the drip-stopping mechanism of the spray head 1 of some implementations, as described in the aspects section above.

Additionally, some implementations may provide a separator 20, which prevents fluid flow between spray plate regions 21. Other implementations may provide elastomeric projections 28 arranged to seal the apertures 31 through the flow splitter. Other implementations, including that pictured in the figures, may provide both a separator 20 and a plurality of elastomeric projections 28. In each example, the flow splitter 30 is arranged to split the fluid input into a plurality of streams, so providing separate flows to each spray plate region as defined by the separator 20, and/or to each of the elastomeric projections 28, or both.

In the implementation shown, the flow splitter 30 is arranged to provide a plurality of separate fluid channels 34 joined only at the fluid inlet, each fluid channel 34 providing one exit aperture 31 of the plurality of exit apertures through the flow splitter. In alternative implementations, the flow splitter 30 may allow fluid to flow freely above it, and may simply split the flow by having a plurality of apertures 31 therethrough, such that the fluid splits in passing portions through different apertures.

In the implementation pictured, the flow splitter 30 is plate-like. The flow splitter is of the same shape as the spray plate 10, and is arranged such that the perimeter 36 of the flow splitter 30 abuts the rim 84 of the spray head cover 80 and typically connects sealingly thereto. The flow splitter 30 is not visible when the spray head 1 is in use.

The upper surface of the flow splitter 30 is shaped to provide channels 34 extending from a central region via which fluid from the fluid inlet 86 reaches the flow splitter. These channels 34 provide the separate fluid channels 34 (with the plate 40, which may be described as a sealing plate accordingly, provided a top surface of each channel).

In other examples, the flow splitter 30 may not be plate-like and may for example instead be provided by a series of enclosed channels. These channels may take the form of pipes, tubes or hollows, connected only at the fluid inlet. In yet other examples, the flow splitter 30 may be provided by a substantially flat plate (without indented channel paths), the flat plate having a plurality of apertures therethrough. In this example, fluid from the fluid inlet may spread naturally across the surface of the flow splitter in response to the pressure of fluid from the fluid inlet, with the fluid flowing through each aperture forming an individual stream as it passes therethrough.

The flow splitter 30 may take any appropriate form that allows the fluid from the fluid inlet 86 to be divided into a plurality of distinct streams.

In implementations which the flow splitter 30 is provided by a plate-like member, the flow splitter may be called a blocking plate. The flow splitter pictured in FIG. 1 may therefore also be referred to as a blocking plate 30 herein. In the implementation pictured, the blocking plate 30 is disposed between the cover 80 and the spray plate 10, within the spray head housing. As in FIG. 1, if a separator 20 is provided, the blocking plate 30 is disposed above the separator 20.

In the implementation pictured, the blocking plate 30 has ridges 32 or other suitable means of connection to secure the blocking plate 30 to other spray head components. This may include connection to the cover 80, the separator 20, and/or the spray plate 10, or any combination of connections that would suitably secure the blocking plate 30 in place within the spray head housing. In additional or alternative implementations, the connections may be provided by, for example, screws, connecting ridges, clips, and/or glue.

In the implementation pictured, when the fluid supply to the spray head 1 is turned on, fluid flowing from the fluid inlet 86 arrives at a first cavity 33 provided by the blocking plate 30. The first cavity 33 is at least substantially circular in shape in this implementation, and is located centrally in the blocking plate 30. The first cavity 33 has a depth less than the thickness of the blocking plate 30, providing a pool for the fluid to enter on first contact with the blocking plate 30.

In alternative or additional implementations, the first cavity 33 may be square, rectangular, or any other suitable shape. The first cavity may not be located centrally on the blocking plate 30, however the first cavity is typically located beneath the aperture through which the fluid is received.

In implementations where the blocking plate 30 is substantially flat, it may be that no first cavity 33 is provided and that the fluid is not bound to a series of cavities and/or channels, instead spreading freely across the blocking plate 30.

In yet other implementations, where the flow splitter 30 is not plate-like and provides a series of enclosed tubes, a first cavity may take the form of an enclosed tube section from which individual tubes/streams disperse, or may not be present at all, for example with barriers oriented along the direction of fluid flow as part of the inlet connectors 50, 60, 70 dividing the incoming fluid flow into portions and directing each portion into a separate pipe.

In the implementation pictured, the blocking plate 30 provides a plurality of fluid channels 34 extending from the first cavity 33 and joined only at the first cavity 33. The blocking plate 30 is therefore arranged to split the fluid flow from the first cavity 33 between the plurality of separate fluid channels 34.

The fluid channels 34 have a depth that is less than the thickness of the blocking plate 30, the blocking plate 30 therefore having grooves that form the fluid channels 34.

The perimeter of each fluid channel 34 has a rim 35 extending upwardly in the direction away from the blocking plate 30 towards the cover 80. This raised rim 35 extends along the full length of the perimeter of each fluid channel 34. The rim 35 acts as a wall, having a substantially equal height along its length, and providing a substantially flat surface at its top.

In other implementations, the height of the raised rim 35 may vary along the perimeter of the fluid channel 34. Additionally or alternatively, the raised rim may only extend along a portion of the perimeter of the fluid channel, or not provide a substantially flat top surface. The raised rim may be provided by an upwardly sloping edge towards each fluid channel, containing the fluid within each individual channel. The raised rim may be provided in any way that confines the fluid to a distinct channel.

The raised rims 35 of each fluid channel in this implementation allow the tops of each channel 34 to be sealed against the sealing plate 40, so facilitating correct functioning of either of the drip-reducing mechanisms disclosed (the “elastomeric projections” and/or the “separator”), both of which involve the fluid input being divided into distinct streams. The raised rims 35 of each fluid channel 34, in conjunction with the sealing plate 40, prevent fluid from flowing between channels, providing a regular and even distribution of water across the surface of the spray plate 10 and enhancing user experience.

The raised rims 35 may also act to increase the depth of each fluid channel without necessarily having to increase the thickness of the blocking plate 30. This may allow for an increased volume of water flow through the spray head without increasing its weight. In alternative implementations, the blocking plate 30 may instead be thicker so as to provide deeper channel 34 without raised rims 35.

In the implementation shown, the raised rim 35 is continuous around all fluid channels 34 and extends to surround the first cavity 33. The raised rim 351 around the first cavity 33 prevents the fluid from flowing out of the first cavity 33 other than into one fluid channel 34 of the plurality of fluid channels. The raised rim 351 around the first cavity 33 ensures that the fluid is directed to one of the plurality of fluid channels 34.

In other examples, the fluid channels 34 and/or first cavity 33 may not have a raised rim 35, and are provided only by intrusion into the body of the blocking plate.

In the implementation pictured a sealing plate 40 is provided. The main body 42 of the sealing plate is substantially plate-like. Mounting the sealing plate 40 in contact with the upper side of the blocking plate 30 creates a ceiling to each fluid channel 34. This completely seals the fluid channels 34 and ensures no fluid can flow between channels (other than via the first cavity 33).

In the implementation pictured, the under-side of the sealing plate provides protrusions 44 arranged to align with the raised rims 35 of each fluid channel 34 provided by the blocking plate 30. Accordingly, when the sealing plate 40 is connected to the blocking plate 30, the raised rim 35 of each fluid channel 34 abuts the protrusions 44 on the lower side of the sealing plate 40, completely enclosing the fluid channels 34. One or more of the protrusions 44 and the raised rims 35 may be made of, or coated with, an elastomeric material that can be compressed so as to form a watertight seal.

In implementations where the raised rim 35 around each fluid channel does not extend the full length of the perimeter of the fluid channel 34, the under-side of the sealing plate 40 may provide protrusions 44 suitable in such a shape that will completely seal the fluid channels 34. In other implementations, the under-side of the sealing plate 40 may be substantially flat. The raised rim 35 of each fluid channel 34 may abut the flat surface, sealing the fluid channel entirely.

The raised rims 35 may be formed of, or include parts made from, an elastomeric material. An elastomeric rim may be appropriately deformed under the pressure applied when the sealing plate 40 is attached, creating a water-tight seal. In other examples, the raised rims 35 may be made of a rigid polymeric material, or may be provided by a combination of elastomeric and rigid materials.

In implementations where the blocking plate 30 does not provide raised rims 35 around each fluid channel 34, the sealing plate 40 may be arranged to seal the fluid channels by abutting the blocking plate directly.

In examples where the blocking plate 30 is provided by a substantially flat surface, or the flow splitter is provided by a series of enclosed tubes, no such sealing plate 40 may be required (although a similar plate 40 may still be present for engagement with various connectors 70).

In the implementation pictured the sealing plate 40 provides fixings 46, 48 for its connection to other spray head components. The sealing plate 40 has a series of apertures 48 through which screws 410 (shown in FIG. 7) secure the sealing plate 40 to the blocking plate 30, passing through holes 37 in the blocking plate 30 in the example shown. These screws 410 may allow an elastomeric part provided by either or both of the sealing plate 40 to the blocking plate 30 to be compressed against the other, so providing a watertight seal. Additionally, the sealing plate 40 pictured provides a screw-like threaded connector 46 surrounding a central opening for connecting the sealing plate to other components, and for directing the fluid from the fluid source which has passed through the aperture 86 onto the blocking plate 30.

In other implementations, the sealing plate 40 may be connected to the blocking plate 30 and other spray head components by any suitable means, for example by screwing, welding, clipping, or gluing.

The sealing plate 40 pictured has a surface area smaller than the blocking plate 30. However, the surface area of the sealing plate 40 is large enough to completely cover the top side of each fluid channel 34 provided by the blocking plate 30. In other examples, the sealing plate 40 may take the same size and shape as the blocking plate, and cover a larger proportion of the blocking plate than in the pictured implementation.

In yet other examples, the sealing function of the plate 40 may be provided by a member arranged to cover only the fluid channels 34 provided by the blocking plate 30, such a member optionally having a shape corresponding to that of the fluid channels 34, so as to fit engagingly to the channels and seal them. In additional or alternative examples, the sealing function of the plate 40 may be provided by a plurality of smaller members, each arranged to seal an individual fluid channel 34, or a portion of an individual fluid channel.

The blocking plate 30 of FIG. 2 provides eight fluid channels 34, each fluid channel 34 extending approximately radially from the first cavity 33, the first cavity 33 located centrally within the blocking plate 30.

Four of the fluid channels 341 pictured extend in a substantially straight line from the first cavity 33 towards the perimeter 36 of the blocking plate. These channels 341 are shorter in length than the other fluid channels 342 (i.e. extend to the perimeter 36 by a lesser amount). The four other channels 342 are longer (i.e. extend further to the perimeter 36) and each include a bend. The cross-sectional area of each fluid channel 34 is approximately equal.

Longer channels 342 may be provided to channel fluid from the first cavity 33 to outer regions 211 of the spray plate 10, whilst shorter channels 341 may be provided to channel fluid from the first cavity 33 to inner regions 213 of the spray plate 10. This may be beneficial in ensuring that there is an even distribution of fluid passing through each exit aperture through the flow splitter 30, and so entering each distinct spray plate region 21 in implementations with a separator 20 as described below. This may assist in making the distribution of fluid exiting from the spray plate 10 regular and even across the entire area of the spray plate 10, enhancing user experience.

Providing fluid channels 34 with approximately equal cross-sectional areas (the areas also being constant along at least the majority of the channel's length in the implementation pictured) may facilitate an approximately equal volume of water flowing through each fluid channel 34.

Providing an even distribution of fluid to all areas of the spray plate 10 is advantageous for the functioning of either of the drip-reducing mechanisms described herein that may be employed within the spray head 1. When including a separator 20 within the spray head 1 it is beneficial if the distribution of fluid to each spray plate region 21 defined by the separator 20 is approximately equal. Given that fluid cannot flow between spray plate regions 21 in such implementations, an even distribution of fluid across the flow splitter 30 before entering the spray plate regions 21 ensures a regular and even distribution of fluid is exiting the spray head 1, providing an enhanced user experience. Additionally, providing an even distribution of fluid to all areas of the spray plate 10 is equally as advantageous when considering a spray head 1 using the elastomeric projection drip-reducing mechanism. Keeping the pressure exerted by the fluid on each elastomeric projection in the plurality of elastomeric projections at least approximately equal, so as not to overly strain an individual elastomeric projection, may be advantageous to functioning and life-span. Overly straining a single projection may lead to reduced elasticity and permanent deformation of said projection, weakening the drip-reducing abilities of the spray head 1.

In other implementations, the flow splitter 30 may provide between four and twenty exit apertures 31, and optionally between four and twelve exit apertures 31. In implementations using separate fluid channels 34, the number of fluid channels may be equal to the number of exit apertures 31. Alternatively, two or more exit apertures 31 may be provided on at least some of the fluid channels 34, for example with the channel branching and having an exit aperture 31 for each branch. In alternative or additional implementations, the fluid channels may each be of different cross-sectional areas, and may provide paths of different lengths (e.g. extending different amounts towards the perimeter of the blocking plate, and/or bending). Alternatively, the fluid channels may each have the same cross-sectional area and/or the same length. The fluid channels may be straight, bent, or curved. Fluid channel shapes and locations may be arranged to ensure fluid is channelled evenly to all areas of the spray plate.

In the implementation pictured, the fluid channels 34 form a symmetrical pattern on the blocking plate 30. In other examples, the fluid channels may not form a symmetrical pattern on the blocking plate.

In implementations with a plurality of fluid inlets, the flow splitter 30 may provide a plurality of first cavities 33. The number of first cavities may be equal to the number of fluid inlets. In other examples, the number of first cavities may be less than the number of fluid inlets, and multiple fluid inlets may channel water into the same first cavity 33, so allowing for mixing. In implementations with multiple such cavities 33, each first cavity may have a plurality of extending fluid channels 34 extending therefrom, as described above.

In the implementation shown, each fluid channel 34 has a singular exit aperture 31 through the blocking plate 30. Each exit aperture 31 leads into a cavity 910 formed between the underside of the blocking plate 30 and the upper side of the separator 20 in the implementation shown. In implementations without a separator 20, each exit aperture 31 may instead lead into a cavity 910 formed between the underside of the blocking plate 30 and the upper side of the spray plate 10.

The exit aperture 31 of each fluid channel 34 is located at the end of the fluid channel 34, i.e. at the point furthest from the first cavity 33, in the implementation shown. In other implementations, each fluid channel 34 may have a plurality of exit apertures, which may be located along the length of the fluid channel.

In the implementation shown the width of each exit aperture 31 is approximately 1/40^{th} of the largest width of the spray plate 10, the “largest width” being the diameter of the circular spray plate. In various implementations, the maximum width of each exit aperture 31 of the plurality of exit apertures is at least one twentieth, and optionally at least one tenth, of the largest width of the spray plate 10.

In the implementation shown, the exit apertures 31 are circular. In this case, the largest width of the exit aperture 31 is the diameter of the exit aperture 31. In other examples, the apertures may be oval, square, rectangular, or any other suitable shape. In each instance the largest width of the aperture is the longest/maximum length across the aperture between two points on the perimeter of the aperture.

Similarly, the spray plate 10 pictured in FIG. 1 is circular in shape. Accordingly, the largest width of the spray plate 10 is its diameter. Other implementations may provide spray plates of non-circular shape, and as such the largest width of such a spray plate is the longest length across the spray plate between two points on the perimeter of the spray plate.

In various implementations, the largest width of each exit aperture 31 is at least 2 mm, and optionally at least 3 mm or 5 mm. The largest width of each exit aperture 31 may be in the range from 2 mm to 40 mm, and optionally from 2 mm to 30 mm. Typically, the maximum width of each exit aperture 31 is at least 1.5 times greater than the diameter of each spray plate outlet aperture 16, and optionally at least 2.5 times greater than the diameter of each spray plate outlet aperture 16.

In the implementation pictured, the blocking plate 30 has a constant, set position (position in this instance meaning location and orientation) with respect to the housing 10, 80. The blocking plate 30 is unchanged in use.

In other examples, the position of the blocking plate 30 may be changed as the spray head 1 is turned on or off, and additionally or alternatively may be changed whilst fluid flow through the spray head remains on. For example, movement of the blocking plate 30 could be used to facilitate a mode-changing spray head wherein the movement of certain spray head parts allows for a range of different spray types to be emitted.

As described above, the spray plate 10 is attached to the cover 80 to provide the spray head housing 10, 80. All other components of the spray head 1 are disposed within the spray head housing. The spray plate 10 may also be connected to other spray head components.

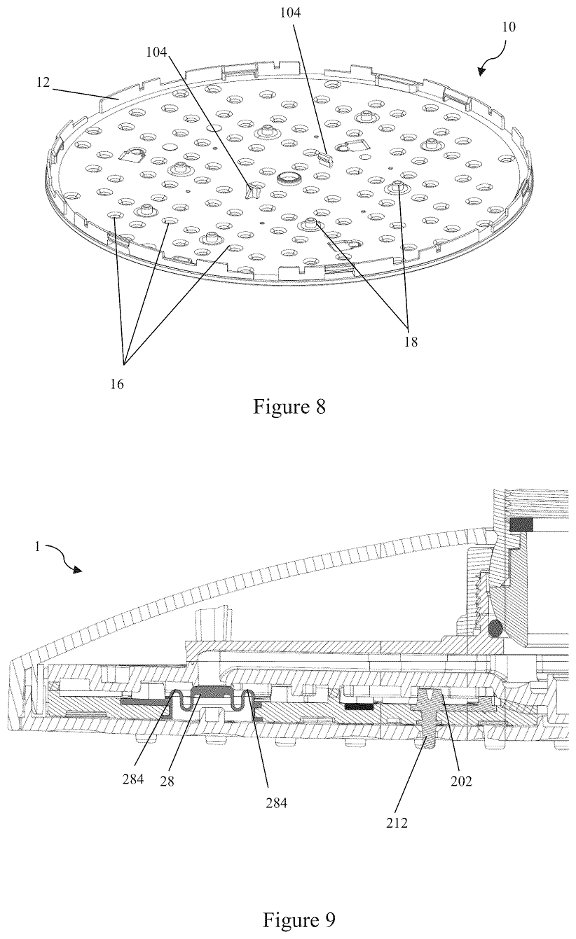

In the implementation pictured, the spray plate 10 contacts the under-side of the separator 20, which fits engagingly within a rim 12 of the spray plate 10. The spray plate 10 pictured (see e.g. FIG. 8) also has a rim 12 having a series of ridges along its perimeter, the ridges used to connect the spray plate 10 to other spray head components. This may include connection to the cover 80, the flow splitter 30, and/or the separator 20, or any combination of connections that would suitably connect to the spray plate to form the spray head housing. Other connectors may be used instead of, or as well as, such ridges in other implementations.

The spray plate 10 also provides a plurality of fixing members 102, which are clips in the implementation shown. These clips provide a direct connection of the spray plate 10 to the blocking plate 30, passing through aligned holes 201 through the separator 20 in the implementation shown. Indentations or apertures 41 are also provided in the sealing plate 40 to provide clearance for these clips in the implementation shown. In additional or alternative implementations, the connections may be provided by, for example, screws, clips, or glue.

The spray plate 10 of various implementations may have a total area greater than 200 cm² and optionally greater than 500 cm², 700 cm², 800 cm², or 1000 cm².

The spray plate 10 has a plurality of spray plate outlet apertures 16. Each spray plate outlet aperture 16 is a substantially flat hole in the implementation pictured, meaning no protrusions or extensions are provided around the aperture by the spray plate 10. However, in this implementation the separator 20 provides protrusions 212 which extend through these outlet apertures so as to provide a nozzle for each outlet aperture 16, as described in more detail below.

In alternative implementations, each spray plate outlet aperture 16 may be associated with a conical extension on the under-side of the spray plate. Each conical extension may be provided to funnel the fluid through a respective spray plate outlet aperture, and may provide the desired direction, flow rate, shape and/or pressure of the fluid stream emerging from the spray plate outlet aperture. The conical extensions may be made of one or other or a combination of an elastomeric material and a rigid material (for example, a polymeric material or a metal). Each conical extension may be made of the same material or combination of materials, or different conical extensions may be made of different materials in order to provide a different fluid stream effect for the user.

Each spray plate outlet aperture 16 may therefore be provided as a nozzle, either due to the shaping of the spray plate 10 itself, or to features provided by other components, e.g. by the separator 20.

The spray plate 10 may be made of a rigid, sturdy material, for example a polymeric material, metal, or equivalent. A rigid spray plate is beneficial in providing suitable protection for the internal spray head components in normal use.

Different implementations of the spray head 1 disclosed may use different drip-reducing mechanisms. In some implementations, the drip-reducing mechanism may be provided by a flow splitter 30 and a separator 20. As described above, the flow splitter 30 is arranged to split the fluid into a plurality of individual streams, with each stream passing through the flow splitter via a different exit aperture 31. The separator 20 is arranged to define a plurality of spray plate regions 21, and to prevent fluid flow between the spray plate regions. In this implementation, each separate fluid stream (provided by the flow splitter) flows into a different spray plate region 21 (provided by the separator 20).

In other implementations, the drip-reducing mechanism may be provided by a flow splitter 30 and a plurality of elastomeric projections 28. As described above, the flow splitter is arranged to split the fluid into a plurality of individual streams, with each stream passing through the flow splitter via a different exit aperture 31. The plurality of elastomeric projections 28 may be located between the flow splitter 30 and the spray plate 10, and arranged to contact respective valve seats when relaxed so as to block fluid flow. In this implementation, each exit aperture 31 through the flow splitter 30 provides a valve seat for a respective elastomeric projection 28.

Although either the separator 20 or the elastomeric projections 28 work well individually to reduce unwanted dripping from a spray head 1, the two approaches may also be combined in a single spray head to provide a further improved drip-reducing mechanism.

A single spray head 1 incorporating both approaches may simultaneously benefit from the aperture-sealing effect provided by the elastomeric projections 28 and the tip-proof and distribution effects provided by the separator 20. The combination of these effects may work together to significantly reduced the unwanted drip from a spray head when not in use, therefore enhancing user experience.

In such implementations, the drip-reducing mechanism may be provided by a flow splitter 30, a separator 20, and a plurality of elastomeric projections 28. It is such an implementation that is pictured in the figures. The remainder of the description will detail both the separator and elastomeric projections together, although it will be appreciated that either one of the two features may be used in isolation in some implementations.

In the implementation pictured, the separator 20 is disposed between the flow splitter 30 and the spray plate 10. The separator 20 is plate-like in shape, and is of at least substantially the same shape as the spray plate 10. The separator 20 is arranged such that the perimeter of the separator abuts the rim 84 of the spray head cover 80, and/or the rim 12 of the spray plate 10. The separator 20 as a whole is not visible when the spray head 1 is in use, however protrusions 212 from the separator 20 are used to form nozzles for each outlet aperture 16 in the implementation shown, and are visible in use as they protrude through the spray plate 10. In other implementations, the separator 20 may not provide such protrusions 212, and may be entirely contained within the spray head housing 80, 10 in use.

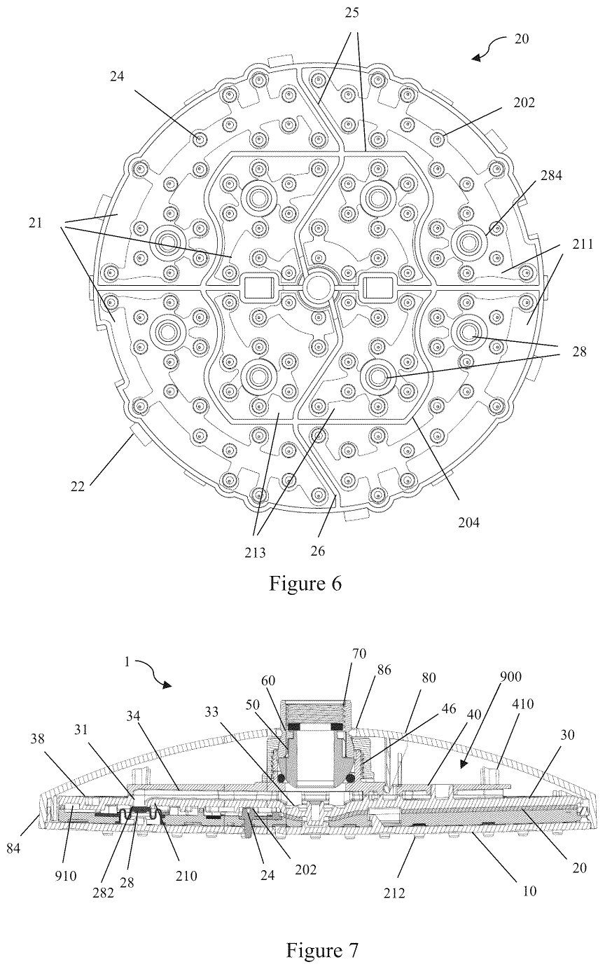

The separator 20, as shown in FIGS. 5 and 6, has ridges 22 along the perimeter to secure the separator to other spray head components. This may include connection to the cover 80, the flow splitter 30, and/or the spray plate 10, or any combination of connections that would suitably hold the separator 20 in place within the spray head housing. In additional or alternative implementations, the connections may be provided by, for example, screws, connecting ridges, clips, or glue.

The separator 20 may be made from or include one or more polymeric materials e.g. rubber, plastics or the likes, which may be elastomeric. In alternative implementations, the separator may be made of a rigid material, or may be made of a combination of both elastomeric and rigid materials.

As described above, the separator 20 is arranged to divide the spray plate 10 into a plurality of spray plate regions 21 such that fluid cannot flow between the spray plate regions 21. The separator 20 therefore provides one or more barriers 25 arranged to define the perimeter of the spray plate regions 21, the barriers 25 also preventing the fluid from flowing between the spray plate regions.

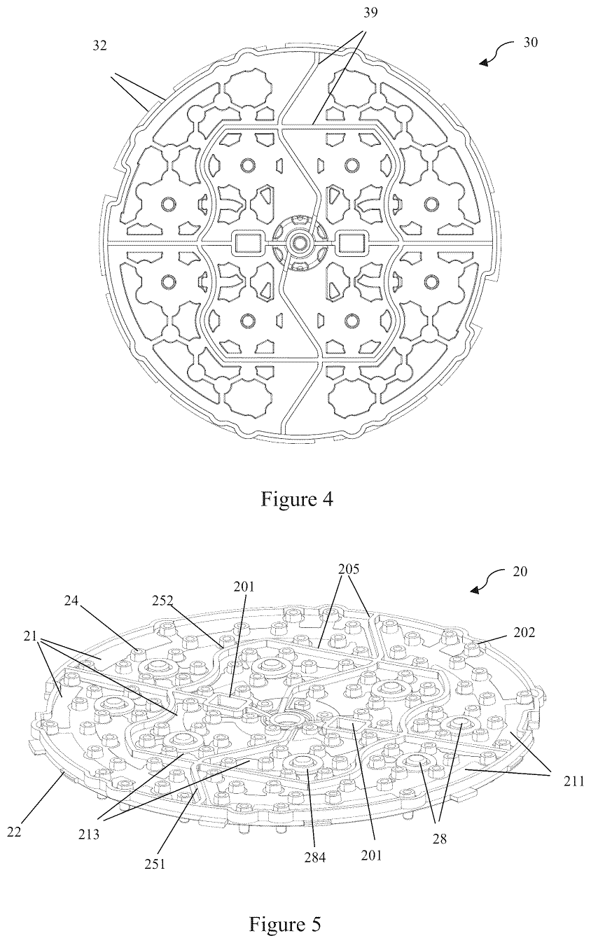

In the implementation pictured, the barriers 25 provided by the separator 20 are a plurality of walls extending behind the separator in the direction of the blocking plate 30. Each wall 25 in the plurality of walls has a substantially equal height along its length, and provides a substantially flat surface at its top. The use of an elastomeric material for these barriers allows them to compress sealingly against an underside of the blocking plate 30, as shown in FIG. 4, to provide a watertight seal between the two.

In alternative implementations, each barrier may be provided by upwardly sloping edges of shaped indentations each providing an individual spray plate region. The barriers 25 may be provided in any way that confines the fluid to distinct spray plate regions 21.

In the implementation pictured the separator 20 is located beneath the blocking plate 30. Locating the blocking plate 30 above the separator 20 defines a cavity 910 between the blocking plate and the separator. This cavity 910 is subdivided into a plurality of smaller cavities by the plurality of walls 25 (or other barriers 25, as applicable to a given implementation), each smaller cavity corresponding to a spray plate region 21.

Contact between the blocking plate 30 and the upper-side of the separator 20 provides a ceiling to each smaller cavity. Each spray plate region 21 and associated cavity are therefore completely sealed, ensuring that no fluid can flow between spray plate regions.

In the implementation shown, the separator 20 is or includes a shaped polymeric elastomeric mat at least substantially the same area as the spray plate 10. A sealing join is provided around their outer edges at the rim 84, so defining an outer perimeter for any spray plate regions 21 which extend to the edges.

The separator mat 20 fits against the spray plate 10 in the implementation shown, such that there is no space therebetween and fluid never touches an upper surface of the spray plate 10 (this may alternatively be described as the separator mat providing an upper surface of the spray plate 10). In other implementations, there may be some space between the separator 20 and the spray plate 10, but water may be prevented from flowing between the two 10, 20.

In still other implementations, the separator 20 may be formed from narrow strips of material—e.g. elastomeric material—arranged to provide barriers 25, and may not provide a layer across the majority of the spray plate 10. The fluid may contact an upper surface of the spray plate 10 in such implementations, with the walls 25 provided by the separator 20 splitting the spray plate into regions 21 between which the fluid cannot flow.

The walls 25 of the separator 20 (which may provide the entirety of the separator in some implementations) may be formed from or include an elastomeric material. The elastomeric walls may be appropriately deformed under the pressure applied when the blocking plate 30 is attached, creating a water-tight seal. In other examples, each wall in the plurality of walls may be made of a rigid, optionally polymeric, material, or may be provided by a combination of elastomeric and rigid materials. Alternatively or additionally, the underside of the blocking plate 30 may be made of, or coated with, an elastomeric material, at least in regions arranged to align with the walls 25 in use.

In FIG. 4 the under-side of the blocking plate 30 of this implementation can be seen to provide protrusions or indentations 39 arranged to align with the walls 25 provided by the separator 20. Accordingly, when the blocking plate 30 is connected to the separator 20, the walls 25 defining each spray plate region 21 abut the protrusions 39, or fit into the indentations, on the lower side of the blocking plate 30, facilitating watertight seals between the spray plate regions 21.

The blocking plate 30 of the implementation shown also has one or more indentations 38 into each spray plate region cavity 21. Providing such indentations advantageously reduces the volume of fluid that can be stored within each cavity (or within the single cavity in implementation without a separator). When the spray head 1 is not in use, this reduces the volume of fluid stored within the spray head and may therefore reduce unwanted dripping from the spray head. In other implementations, the under-side of the blocking plate 30 may be substantially flat, and the walls 25 provided by the separator 20 may abut the flat surface, sealing each spray plate region 21.

In the implementation shown, each spray plate region 21 as defined by the separator 20 has a single fluid inlet. In the implementation pictured, this fluid inlet is one of the plurality of exit apertures 31 through the flow splitter 30. That is to say, once the fluid from the fluid source has been divided into distinct streams by the flow splitter 30, each distinct stream will be channelled into a distinct spray plate region 21. The fluid cannot flow between the fluid channels 34 provided by the flow splitter whilst fluid flow is turned on (as fluid pressure will prevent back-flow), and the fluid cannot flow between the spray plate regions 21 provided by the separator due to the barriers 25. Each fluid channel 34 provided by the blocking plate has a single exit aperture 31, and each exit aperture 31 provides a single fluid source for each spray plate region 21 in this implementation. Accordingly, the number of fluid channels 34, exit apertures 31, and spray plate regions 21 is equal.

In the implementation pictured, each spray plate region 21 defined by the separator 20 has a plurality of spray plate outlet apertures 16. In the example pictured, the spray plate regions 21 each have between eight and twenty outlet apertures 16, and more specifically have ten, eleven, or eighteen outlet apertures. Numbers may vary in other implementations, but typically at least five outlet apertures 16 may be provided per spray plate region 21. A maximum number of outlet apertures 16 per spray plate region 21 may be no more than one quarter of the total number of outlet apertures 16, in implementations using a separator 20 (the spray plate may be described as having a single “spray plate region” in implementations without a separator 20).

Each aperture 24 through the separator 20 is associated with a conical extension 212 on the under-side of the separator 20 in the implementation shown. The conical extensions 212 protruding from the separator 20 are each arranged to sit within a respective spray plate outlet aperture 16 through the spray plate 10 (there is a 1:1 mapping of separator outlets 24 to spray plate outlet apertures 16). Each conical extension protruding from the separator passes through the respective spray plate outlet aperture 16 through the spray plate 10 and has a length longer than the depth of the spray plate, causing the conical extensions 212 to protrude beyond the spray plate and towards the user (so forming nozzles).

Each conical extension 212 is provided to funnel a portion of the fluid from a spray plate region 21 through a spray plate outlet aperture 16. The conical extensions 212 may assist in providing the desired direction, flow rate, shape and/or pressure of the fluid stream emerging from the spray head 1. The conical extensions may be made of one or other or a combination of an elastomeric material and a rigid material (for example, a polymeric material or a metal). Each conical extension may be made of the same material or combination of materials, or different conical extensions may be made of different materials in order to provide different fluid stream effects for the user. Each conical extension 212 may therefore provide shaping for a spray plate outlet aperture, and/or may be a nozzle. In other examples, each spray plate outlet aperture 16 may be a substantially flat hole, with no associated conical extension.

In alternative implementations, the separator 20 may be provided by one or more other spray head components, rather than being provided as a separate item. For example, the separator 20 may be provided by the under-side of the flow splitter 30. In such an implementation, the under-side of the flow splitter 30 may provide a plurality of barriers extending from the flow splitter in the direction of the spray plate 10. The plurality of barriers may divide the spray plate 10 into a plurality of spray plate regions 21, so performing the role of the separator 20.

In this implementation, the spray plate 10 may abut the under-side of the flow splitter 30, making contact with the protrusions. Accordingly, the spray plate 10 seals each cavity provided by the barriers on the under-side of the flow splitter 30, defining a plurality of water-tight cavities corresponding to respective spray plate regions. Each cavity may be provided by a single fluid inlet. This single fluid inlet may be an exit aperture 31 through the flow splitter 30. Each spray plate region 21 may also have a plurality of spray plate outlet apertures 16, each spray plate outlet aperture optionally being associated with a conical extension on the under-side of the spray plate 10. Alternatively, each spray plate outlet aperture 16 may be a substantially flat hole, with no associated conical extension.

In yet another implementation, the separator 20 may be provided, for example, by the upper-side of the spray plate 10. The upper-side of the spray plate may provide a plurality of barriers extending from the spray plate in the direction of the flow splitter 30. The plurality of barriers may divide the spray plate into a plurality of spray plate regions 21. In this implementation, each barrier of the plurality of barriers provided by the spray plate 10 may abut the under-side of the flow splitter 30. Accordingly, the flow splitter seals each cavity provided by the barriers, defining a plurality of water-tight cavities corresponding to respective spray plate regions 21. Each cavity may be provided by a single fluid inlet. This single fluid inlet may be an exit aperture 31 through the flow splitter 30. Each spray plate region may also have a plurality of spray plate outlet apertures 16, each spray plate outlet aperture optionally being associated with a conical extension on the under-side of the spray plate. Alternatively, each spray plate outlet aperture may be a substantially flat hole, with no associated conical extension.

In the implementation shown, the outer spray plate regions 211 are larger than the inner spray plate regions 213 and have a correspondingly larger number of outlet apertures 16. In some implementations, especially where spray plate regions 21 are of more equal sizes, each spray plate region 21 may have an approximately equal number of spray plate outlet apertures 16. This may be advantageous in ensuring that a regular and even distribution of fluid is exiting the spray head from the entire area of the spray head, providing an enhanced user experience. Spray plate outlet apertures 16 may be split between spray plate regions 21 at least substantially proportionally to their relative areas.

Each wall in the plurality of walls 25 of the implementation shown has a curved or bent shape. This may allow for curvature around individual spray plate outlet apertures, and/or more flexibility on groupings of spray plate outlet apertures than would be provided by strictly straight barriers 25.

In other implementations, the walls 25 provided by the separator may be substantially straight. Alternatively, the walls may have a combination of straight, curved and/or bent sections.

In the pictured implementation, each spray plate outlet aperture 16, 24 has a raised rim 202 provided by the separator 20, around a perimeter of the separator outlet aperture 24 (aligned with a corresponding spray plate outlet aperture) and extending towards the blocking plate 30. The raised rim 202 of each spray plate outlet aperture may allow any residual fluid left in the cavity of the spray head when the spray head is turned off to be contained within the spray head 1, provided its depth does not exceed the rim height, so reducing unwanted dripping.

Additionally, the height of the raised rim 202 of a spray plate outlet aperture 24 is less than the maximum height of each wall of the plurality of walls 25, ensuring that when the spray head is in use fluid can flow over the raised rim and out of the spray head, but cannot flow between spray plate regions 21.

In various implementations, including that pictured, the plurality of walls 25 includes a plurality of first walls 251 radiating from a central point on the separator so as to divide the spray plate into a plurality of segments, and at least one second wall 252 extending between adjacent pairs of first walls, the second wall arranged to sub-divide the segments, so forming the plurality of spray plate regions 21.

In the pictured implementation, the separator 20 provides four first walls 251, each extending radially from the central point to the perimeter (either in a straight line, or with one or more bends, as pictured). Each first wall 251 sits at an angle of 90° (on average) from the adjacent first wall, thereby dividing the spray plate into four at least substantially equally sized segments (quarters).

The pictured implementation has one second wall 252, extending fully around the centre of the separator 20, spaced from the centre of the separator, and sub-dividing each of the four segments provided by the plurality of first walls 251 into two. The separator 20 as shown in FIG. 5 therefore has eight spray plate regions 21. The second wall 252 is substantially rectangular in shape in the implementation shown, although could be more circular in other implementations.

In alternative implementations, the separator 20 may provide an increased or decreased number of first walls 251 and/or second walls 252. Accordingly, implementations may have an increased or decreased number of spray plate regions 21.

The spray head 1 pictured may therefore be described as having a plurality of walls 25 including n first walls 251 radiating from a central point on the spray plate 10 so as to divide the spray plate into n spray plate regions 21, wherein n≥2. In some cases, the very centre of the spray plate 10 may have a connector or similar such that the walls 25 do not reach the central point—however, the geometry is such that they extend at least substantially radially away from that point. Each first wall 251 of the plurality of walls 25 extends from the central point on the spray plate 10 to the edge of the spray plate. For the example pictured, n=4 for this definition as the straight line across the diameter of the spray plate 10 provides two aligned walls along the respective radii. Values of n may vary in other implementations, for example being n=3, n=5, n=6, n=7, or n=8.

In the implementation shown, each spray plate region 21 has an average extent along the radius of no more than around half of the radius, so no more than around a quarter of the diameter (which is the largest width of the spray head 1). More generally, each spray plate region 21 of various implementations may have an extent parallel to a width of the spray plate 1 of less than a third of the total/largest spray plate width.

In the implementation shown, each spray plate region 21 extends no more than a quarter of the way around/parallel to the circumference of the spray plate 10, which may also be described as extending no more than a quarter of the way around a central point of the spray plate 10. More generally, each spray plate region 21 of various implementations may have an extent parallel to a perimeter of the spray plate of less than a third of the total spray plate perimeter.

In the implementation shown, the first walls 251 extend across the diameter of the spray plate 10, which is its largest width. More generally, each spray plate region 21 of various implementations may have at least one wall of the plurality of walls 25 which extends fully across the largest width of the spray plate 10, which may reduce a maximum distance retained fluid can travel when the spray head 1 is tipped.

The use of a separator 20 may be particularly advantageous in large spray heads that store large volumes of fluid internally, even when the spray head is not in use. Where a large volume of fluid may be pooled within one region of a spray head (for example, the spray head has been tipped), the fluid may have a depth or flow speed great enough to allow it to mount the raised rim (where present) provided by the spray plate outlet aperture 16 and the conical extension 212 and begin to drip out of the spray head 1. This generates unwanted wastewater and a potentially irritating dripping sound. Including a separator 20 with a plurality of distinct spray plate regions 21 prevents fluid from flowing between regions and from gathering at one end of the spray plate 10. Unwanted dripping may therefore be reduced, with a decreased chance of water reaching the required depth or velocity to mount the rim and escape through an aperture, even when the spray head is suddenly tipped to a steep angle.

The separator 20 of various implementations may provide at least five spray plate regions 21. Optionally, the number of spray plate regions 21 does not exceed twenty, and optionally does not exceed fifteen.

In the pictured implementation, each of the eight spray plate regions 21 has an area of around one eighth of the total spray plate area. More generally, for N spray plate regions 21, each may have an area of around 1/N of the total spray plate area.

In the pictured implementation, no spray plate regions extend fully around the central point of the spray head 1. Additionally, no spray plate regions extend the full length or width of the spray head 1.

Designs in which fluid cannot flow between regions in this way may therefore reduce the pooling of large volumes of fluid at one side of the spray plate 10, therefore significantly reducing the unwanted dripping effect when the spray head 1 is not in use.

In alternative implementations, the spray plate regions 21 may be of different areas. Additionally or alternatively, the separator may provide spray plate regions that do extend fully around the central point of the spray head. Having regions extending fully around the central point of the spray head may be more suitable in small spray heads, or for a central region of larger spray heads, where the volume of fluid stored internally is minimal and the size of a region encircling the central point is small.

In the pictured implementation, the separator 20 is circular in shape and has approximately the same surface area as the spray plate 10 and blocking plate 30. Therefore, the separator is arranged to substantially cover the entire upper-surface of the spray plate and the entire lower-surface of the blocking plate. The largest width of the separator 20 is the diameter of the separator.

In other examples, the separator 20 may be ovular, square, rectangular, or any other suitable shape. In such implementations, it is advantageous if the shape of the separator 20 is substantially the same as the shape of the spray plate 10, and alternatively or additionally substantially the same as the shape of the flow splitter 30 to provide fitting engagement with one or both of the spray plate 10 and flow splitter 30. In these implementations, the largest width of the separator 20 is the longest distance across the separator between two points on the perimeter of the separator. The largest width of the separator may be equal to the largest width of the spray plate 10 and/or the flow splitter 30, In alternative implementations, the separator 20 may instead be provided as a set of individual barriers, or an interlinked web of barriers, and may be held in place by compression between adjacent layers (or by gluing or similar).

The volume of fluid received into each spray plate region 21 is dependent on the volume of fluid diverted into each fluid channel 34 of the flow splitter 30. In FIG. 1 the flow splitter is fixed such that the proportion of fluid flow from the fluid inlet 86 that is directed to each fluid channel 34 does not change substantially. Accordingly, the proportion of fluid from the fluid inlet 86 that is directed to each spray plate region 21 is approximately constant in use.

In the pictured implementation, the volume of fluid from the fluid inlet 86 that is directed to each spray plate region 21 is also approximately equal. This is provided primarily by the approximately equal cross-sectional areas of each fluid channel 34 provided by the flow splitter 30.

In other examples, the position (i.e. location and orientation) of the flow splitter 30 may be changed as fluid flow to the spray head is turned on or off, and additionally or alternatively may be changed whilst the fluid flow to the spray head remains on. For example, movement of the flow splitter 30 could be used to facilitate a mode-changing spray head wherein the movement of certain spray head parts allow for a range of different spray types to be emitted.

In such an implementation, the proportion of fluid from the fluid inlet 86 that is directed to each spray plate region 21 may vary based on the user's preferred spray type.

In some implementations, including that pictured, the drip-reducing mechanism may be provided by a flow splitter 30 and a plurality of elastomeric projections 28 in addition to (or instead of) a separator 20. As described above, the flow splitter 30 is arranged to split the fluid into a plurality of individual streams, with each stream passing through the flow splitter via a different exit aperture 31. The plurality of elastomeric projections 28 may be located between the flow splitter 30 and the spray plate 10, and arranged to contact respective valve seats when relaxed so as to block fluid flow (as shown in FIG. 9), and to deform away from the valve seats under fluid flow pressure (as shown in FIG. 11), so as to allow fluid flow when the fluid flow is turned on. In this implementation, each exit aperture 31 through the flow splitter provides a valve seat for a respective elastomeric projection 28—the perimeter of the exit aperture 31 is the valve seat 31.

The plurality of elastomeric projections 28 is located between the flow splitter 30 and the spray plate 10, and arranged to contact respective valve seats 31 provided by the flow splitter 30 when relaxed so as to block fluid flow.

In the pictured implementation, the spray head 1 has a separator 20 with elastomeric components, and the elastomeric projections 28 are provided by the separator 20. The separator 20 is arranged as described above, and additional details of the plurality of elastomeric projections as shown in FIG. 5 are provided below.

In implementations where the spray head does not include a separator, the elastomeric projections 28 may be provided by one or more other components. For example a disc layer (not pictured), placed between the flow splitter and the spray plate. The disc layer may be substantially plate-like, and of the same shape as the spray plate 10. The disc layer may be arranged such that the perimeter of the disc layer abuts the rim 84 of the spray head cover 80. The disc layer may not be visible when the spray head 1 is in use, or may be partially visible due to protrusions like those 212 described above for the separator. Effectively, the disc layer may be equivalent to the separator 20 but without walls 205 or other barriers. It will be appreciated that for non-round spray-heads, the layer may not be disc-shaped and that “disc” is used here for ease of description only, and not to be interpreted as limiting. The disc layer may have ridges along the perimeter to connect the disc layer to other spray head components. This may include connection to the cover 80, the flow splitter 30 and/or the spray plate 10, or any combination of connections that would suitably hold the disc layer in place within the spray head housing. In additional or alternative implementations, the connections may be provided by, for example, screws, connecting ridges, clips, or glue. The disc layer may be made from or include one or more elastomeric materials e.g. rubber, plastics or the likes. In alternative implementations, the disc layer may be made of a rigid material, with elastomeric protrusions 28 mounted thereon.

In yet other implementations, the elastomeric projections 28 may be provided by other spray head components. For example, the elastomeric projections may be provided by the spray plate 10 (extending upwardly from an upper surface thereof). The elastomeric projections 28 may be provided by any spray head component that is suitably situated so as to allow the elastomeric projections 28 to block fluid flow when relaxed, and may each be provided as individual elements rather than as part of a mat.

In the pictured implementation, a separator 20 is present and each spray plate region 21 defined by the separator 20 has a single elastomeric projection 28. Each elastomeric projection 28 is located beneath the respective exit aperture 31 through the blocking plate 30, which provides a fluid source for the respective spray plate region.

As shown in FIG. 7, when the spray head 1 is not in use and the fluid pressure is below a threshold, the elastomeric projection 28 of each spray plate region 21 is relaxed and abuts the perimeter of the respective exit aperture 31 through the blocking plate. The exit aperture therefore forms a valve seat 282, with the elastomeric projection acting as a valve body. This prevents water flow into the cavity 910 associated with the spray plate region 21. Accordingly, fluid cannot flow through the spray plate outlet apertures 24 within the spray plate region 21, and does not exit the spray head 1. This results in reduced dripping when the spray head 1 is not in use.

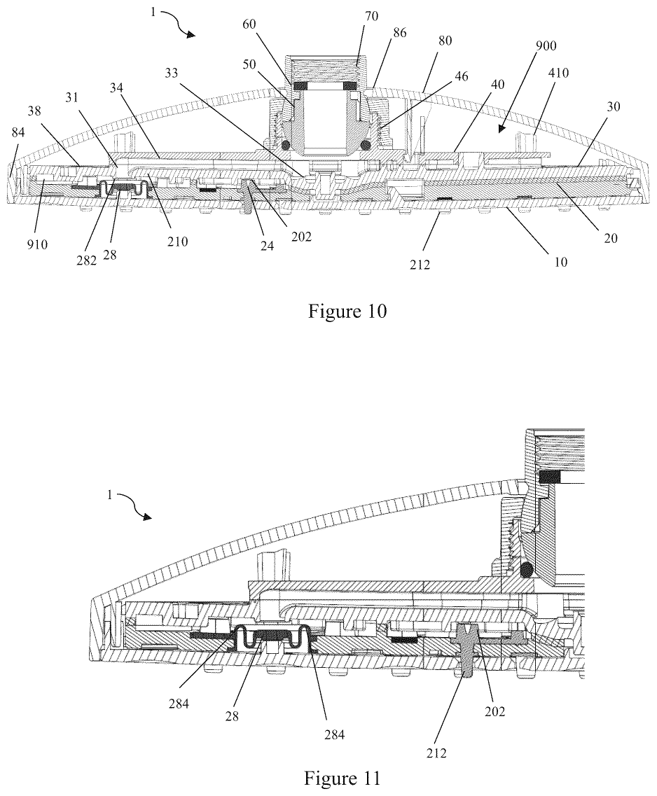

As shown in FIG. 10, when the spray head 1 is turned on, fluid enters the spray head and is divided into the individual fluid channels 34 provided by the flow splitter 30. Accordingly, the fluid pressure at each exit aperture 31 through the flow splitter increases. When this fluid pressure increases above a threshold, the respective elastomeric projection 28 deforms away from the exit aperture 31 in the direction of the spray plate 10. The deformation of the elastomeric projection 28 opens the exit aperture 31 and allows fluid to flow into the respective spray plate region 21. The fluid may then pass through the spray plate outlet apertures 16 within the spray plate region, and exit the spray head 1. When the elastomeric members 28 have been deformed downwardly, towards the spray plate, the volume of the cavity 910 between the blocking plate 30 and the separator 20 (if present, or the spray plate 10 directly if not) is increased to a maximum.

When the fluid flow is turned off, the elastomeric members 28 relax upwardly, into the position shown in FIG. 9. The volume of the cavity 910 between the blocking plate 30 and the separator 20 is decreased correspondingly, which may assist in expelling remaining fluid from the spray head 1 promptly.

In the pictured implementation, each spray plate region 21 has a single elastomeric projection 28 and accordingly the number of elastomeric projections is equal to the number of exit apertures 31 of the flow splitter 30. Each exit aperture 31 effectively provides a single fluid source for its respective spray plate area 21 in such implementations. In implementations having more than one exit aperture 31 per spray plate region 21 (including examples with no separator 20, where all flow splitter exit apertures 31 lead to the same continuous cavity 910), the number of elastomeric projections 28 per spray plate region may increase accordingly. The number of elastomeric projections 28 in a spray plate region 21 need not be equal across all the spray plate regions, and may for example vary based on spray plate region size or location (e.g. providing more exit apertures 31, and so more elastomeric projections 28 in a central region of a spray plate 10, and a lower areal density of exit apertures 31/elastomeric projections 28 further out).

In the implementation pictured, the number of elastomeric projections is eight. In various implementations, the number of elastomeric projections may not exceed twenty, and optionally may not exceed fifteen. The number of elastomeric projections 28 may vary widely between implementations. For example, larger spray heads 1 may benefit from larger spray plates 10 with multiple fluid inputs 86 having an increased number of elastomeric projections 28, whilst smaller spray plates may have fewer elastomeric projections.

In all implementations, the ratio of the number of elastomeric projections 28 to the number of exit apertures 31 through the flow splitter will remain 1:1.

In the pictured implementation, each elastomeric projection 28 is at least substantially dome-shaped (having circular symmetry and a central peak). In various implementations, including that pictured, the elastomeric projection 28 may have a more rigid upper portion to provide a strong seal against the valve seat 31 provided by the exit aperture, and a more flexible lower portion to provide the biasing force to push the upper portion back into contact with the valve seat 31 when fluid flow is turned off. In some implementations, including the one pictured, the more flexible lower portion may provide a rolling section 284 surrounding the e more rigid central portion of the elastomeric projection 28, the cross-section of the rolling section 284 being U-shaped (as pictured in FIG. 9 and FIG. 11). The rolling section 284 may be provided to allow the upper portion of each elastomeric member 28 to “roll” into the deformed position, as opposed to stretching beyond a desired amount. Reducing the amount by which the upper portion of each elastomeric member 28 is forced to stretch when the fluid flow through the spray head 1 is turned on may reduce the amount of fluid pressure required to deform each elastomeric projection. Accordingly, the likelihood of permanent deformation of any individual elastomeric projection 28 may also be reduced.

In the relaxed position, the central part of the dome-shaped elastomeric projection 28 is uppermost, with the rolling section 284 forming a ring around it with a lower peak. In the deformed position, the ring of the rolling section 284 is higher than the central portion of the elastomeric projection 28 in the implementation shown (this may vary in other implementations).

In other implementations, the elastomeric projections 28 may be simple elastomeric domes with constant properties across their areas. In alternative implementations, the elastomeric projections 28 may take the form of ball valves, elastomeric sheets, or any other suitable arrangement that would appropriately seal the exit aperture 31 through the blocking plate 30 when relaxed.

Each elastomeric projection 28 is at least substantially impermeable, such that fluid can only pass through the blocking plate 30 when the elastomeric projection is deformed away from its respective valve seat 31.

In the implementation pictured, there is approximately one elastomeric projection 28 per 35 cm² area of the spray plate 10. In alternative implementations, the number of elastomeric projections may not exceed one per 4 cm² of the area of the spray plate, and optionally may not exceed one per 10 cm² of the area of the spray plate, or one per 20 cm² of the area of the spray plate (e.g. having a 50 mm diameter around each elastomeric projection).

Depending on the size of the spray head 1, and accordingly the volume of fluid flow through the spray head, the number of elastomeric projections 28 used may be calculated to ensure that the pressure exerted by the fluid on each elastomeric projection is distributed appropriately. It is advantageous if the fluid pressure is exerted approximately evenly across the elastomeric projections 28, so as not to overly strain an individual elastomeric projection. Overly straining a single elastomeric projection may lead to reduced elasticity and permanent deformation of said projection, weakening the drip-reducing abilities of the spray head 1. Additionally or alternatively, providing each elastomeric projection 28 with a rolling section 284 may further reduce the strain on each elastomeric projection 28, reducing the likelihood of permanent deformation and improving the lifetime of the drip-reducing mechanism. In the pictured implementation, the spray plate 10 has a plurality of supporting protrusions 18, each supporting protrusion 18 located beneath a respective elastomeric projection 28 (e.g. by the spray plate 10 being connected to the underside of the separator 20 with suitable alignment, in the implementation pictured). Each supporting protrusion 18 is arranged to support a respective elastomeric projection and prevent the elastomeric projection 28 from deforming to such an extent that it cannot return to a relaxed position when the fluid pressure has suitably decreased. These protrusions 18 may help to prevent permanent deformation, or mis-alignment, of the elastomeric projections 28. Each supporting protrusion 18 takes the form a cylindrical member extending upwardly from the spray plate 10 in the direction of the separator 20. Each supporting protrusion sits within the hollow formed beneath the respective elastomeric projection 28. In the pictured implementation, there is a 1:1 ratio of the number of supporting protrusions 18 on the spray plate to the number of elastomeric projections 28.

In alternative implementations, the supporting protrusions 18 may take the form of a biasing member such as a spring, so providing some flexibility and upward bias if the elastomeric projection 28 deforms too far. The size and/or shape of each supporting protrusion 18 may be adapted for the particular elastomeric projection design of a given implementation. Additionally or alternatively, the ratio of the number of supporting protrusions 18 to the number of elastomeric projections 28 may be less than one.

In the implementation pictured, each elastomeric projection 28 has been provided with a rolling section 284 and a supporting protrusion 18. In alternative implementations, each elastomeric projection 28 may be provided with only one or other of a rolling section 284 and a supporting protrusion 18.

As described above, in implementations with a separator, each spray plate region 21 provided by the separator has a plurality of spray plate outlet apertures 24, which may be nozzles.

In the pictured implementation, each spray plate region 21 has at least ten spray plate outlet apertures 24. The ratio of the number of spray plate outlet apertures 24 to the number of elastomeric projections 28 varies from 10:1 to 18:1 between different spray plate regions in this implementation. In other examples, the ratio of the number of spray plate outlet apertures to the number of elastomeric projections may vary more widely, and may be at least 4:1, and optionally in the range from 4:1 to 30:1. For example, in various implementations the ratio may be in the range from 4:1 to 20:1, or from 8:1 to 20:1, and optionally may be at least 8:1 or 10:1.

As in the pictured implementation, and as described above, each spray plate outlet aperture 16 is associated with a conical extension 212, so as to provide a nozzle, and may therefore be described as a nozzle. A ratio of nozzles to of elastomeric projections may therefore be at least 4:1.

In the pictured implementation, the separator 20 has a constant, set position (i.e. location and orientation). The only component of the separator that moves during shower use is the plurality of elastomeric projections 28 acting to seal and unseal the exit apertures 31 through the blocking plate. All other components of the separator 20 are unchanged in use. In other examples, the position of the separator 20 may be changed as the spray head is turned on or off, and additionally or alternatively may be changed whilst the spray head remains on. For example, movement of the separator could be used to facilitate a mode-changing spray head wherein the movement of certain spray head parts allow for a range of different spray types to be emitted.

It will be understood that the invention is not limited to the implementations described above. Various modifications and improvements can be made without departing from the concepts disclosed herein. Except where mutually exclusive, any of the features may be employed separately or in combination with any other features and the disclosure extends to all combinations and sub-combinations of one or more features disclosed herein.

1. A spray head, the spray head comprising:
a fluid inlet;
a spray plate comprising a plurality of spray plate outlet apertures;
a flow splitter located between the fluid inlet and the spray plate, the flow splitter comprising a plurality of exit apertures through the flow splitter, and wherein the perimeter of each exit aperture is arranged to form a valve seat; and
a plurality of elastomeric projections located between the flow splitter and the spray plate, each elastomeric projection being arranged to contact a respective valve seat when relaxed so as to block fluid flow, and to deform away from the respective valve seat when fluid pressure from the inlet exceeds a threshold,
and wherein a ratio of the number of spray plate outlet apertures to the number of elastomeric projections is at least 4:1.

2. The spray head of claim 1, wherein the flow splitter is arranged to provide a plurality of separate fluid channels joined only at the fluid inlet, each fluid channel providing one exit aperture of the plurality of exit apertures through the flow splitter.

3. The spray head of claim 1, wherein at least one of the following applies:
(i) the number of elastomeric projections is equal to the number of exit apertures of the flow splitter;
(ii) the number of elastomeric projections does not exceed one per 4 cm² of the area of the spray plate; and
(iii) the number of elastomeric projections does not exceed twenty.

4. The spray head of claim 1, wherein at least one of the following applies:
(i) a largest width of each exit aperture is at least 0.2 cm;
(ii) the largest width of each exit aperture is in the range from 0.2 cm to 3 cm;
(iii) the largest width of each exit aperture of the plurality of exit apertures is at least one twentieth of the largest width of the spray plate; and
(iv) the largest width of each exit aperture is at least 2.5 times greater than a largest width of each spray plate outlet aperture.

5. The spray head of claim 1, wherein each spray plate outlet aperture has a raised rim around a perimeter of the spray plate outlet aperture and extending towards the flow splitter, wherein a maximum height of each elastomeric projection is greater than an upwards extension of each raised rim of the spray plate outlet apertures.

6. The spray head of claim 1, wherein each elastomeric projection is dome shaped.

7. The spray head of claim 1, wherein the spray plate is divided into a plurality of spray plate regions such that fluid cannot flow between the spray plate regions.

8. A spray head, the spray head comprising:
a fluid inlet;
a spray plate comprising a plurality of spray plate outlet apertures;
a flow splitter arranged to split fluid flow from the inlet into a plurality of portions and to direct each portion to a different region of the spray plate; and
a separator arranged to define borders of the spray plate regions, so defining a plurality of spray plate regions each comprising at least one of the spray plate outlet apertures, and to prevent fluid flow between the spray plate regions,
and wherein the separator defines at least eight spray plate regions, each spray plate region comprising a single inlet from the flow splitter.

9. The spray head of claim 8, wherein each spray plate region has an extent parallel to a width of the spray plate of less than a third of the total spray plate width, and an extent parallel to a perimeter of the spray plate of less than a third of the total spray plate perimeter.

10. The spray head of claim 8, wherein the separator comprises a plurality of walls extended behind the spray plate, the walls arranged to prevent fluid flow between the spray plate regions.

11. The spray head of claim 10, wherein the plurality of walls comprises:
a plurality of first walls radiating from a central point on the spray plate so as to divide the spray plate into a plurality of segments; and
at least one second wall extending between adjacent pairs of first walls, the second wall arranged to sub-divide the segments, so forming the plurality of spray plate regions.

12. The spray head of claim 10, wherein the plurality of walls comprises n first walls radiating from a central point on the spray plate so as to divide the spray plate into n spray plate regions wherein n≥2.

13. The spray head of claim 10, wherein at least one of the following applies:
(i) at least one wall in the plurality of walls extends along at least a majority of the length of a largest dimension of the spray plate; and
(ii) each first wall of the plurality of walls extends from the central point on the spray plate to the edge of the spray plate.

14. The spray head of claim 8, wherein the single inlet to each spray plate region is sealable so as to prevent water flow into the region.

15. The spray head of claim 8, wherein each spray plate outlet aperture is located within a spray plate region of the plurality of spray plate regions.

16. The spray head of claim 8, wherein the flow splitter is fixed such that the proportion of fluid flow from the fluid inlet that is directed to each spray plate region does not change.

17. The spray head of claim 8, wherein at least one of the following applies:
(i) each spray plate region has a substantially equal area; and
(ii) the number of spray plate outlet apertures in each spray plate region is substantially equal.

18. The spray head of claim 8, wherein none of the spray plate regions extend fully around the central point of the shower head.

19. The spray head of claim 8, wherein the separator and flow splitter each have a constant set position and shape.

20. The spray head of claim 8, wherein each spray plate outlet has a raised rim around a perimeter of the spray plate outlet aperture and extending towards the flow splitter.

21. The spray head of claim 8, wherein each spray plate region comprises at least ten spray plate outlet apertures.

22. The spray head of claim 8, wherein the spray plate has a total area greater than 200 cm².
